(19) United States
(12) Patent Application Publication
(10) Pub. No.: US 2026/0140270 A1
(43) Pub. Date: May 21, 2026

(54) RADIATION IMAGING APPARATUS AND RADIATION IMAGING SYSTEM

(71) Applicant: CANON KABUSHIKI KAISHA, Tokyo (JP)

(72) Inventors: RYO EZURE, Tokyo (JP); KATSURO TAKENAKA, Saitama (JP)

(21) Appl. No.: 19/386,857

(22) Filed: Nov. 12, 2025

(30) Foreign Application Priority Data
Nov. 18, 2024 (JP) 2024-200564

(51) Int. Cl. G01T 1/24

(52) U.S. Cl. CPC G01T 1/247

(57) ABSTRACT

A radiation imaging apparatus includes a plurality of pixels, each including a conversion element configured to convert radiation or light into a charge and a switch element, is arranged in a matrix, a driving unit configured to output driving signals that drive the switch elements, and a reading unit configured to read a charge from a pixel to which a driving signal is supplied and generate an image data signal, wherein a first driving signal is output to a first driving line and a second driving signal is output to a second driving line adjacent to the first driving line by shifting timings to reduce line noise along the driving lines, and wherein an image data signal is generated by totaling a first charge read from a pixel by outputting the first driving signal and a second charge read from a pixel by outputting the second driving signal.

### BACKGROUND

### Field of the Technology

The present disclosure relates to a radiation imaging apparatus that acquires the intensity distribution of radiation passing through an object as an image, and a radiation imaging system.

### Description of the Related Art

In recent years, as an imaging apparatus for use in medical diagnostic imaging or nondestructive inspection using an X-ray, a radiation imaging apparatus using a flat-panel detector (hereinafter abbreviated as "FPD") formed of a semiconductor material is put to practical use.

This FPD is composed of photodiodes and switch elements (thin-film transistors (TFTs)) having amorphous silicon as a main material placed on an insulating substrate such as a glass substrate or the like. It is possible to convert radiation such as an X-ray or the like passing through a subject such as a patient or the like into a charge signal using the FPD, perform analog-to-digital conversion on the charge signal, and acquire a transmission image of the subject as a digital image. In recent years, there is also a case where switch elements (TFTs) are composed of indium gallium zinc oxide (IGZO) as a main material instead of amorphous silicon.

In radiation imaging using the FPD, in addition to still image capturing, moving image capturing for reading an image at high speed can also be performed. The moving image capturing requires the reading of an image at high speed and the achievement of a high frame rate.

In the radiation imaging apparatus, a plurality of pixels arranged in a matrix is connected together by wires (driving lines) extending in the row direction and wires (signal lines) extending in the column direction. Then, an on signal is supplied from a driving circuit via a driving line, and image data is read via a signal line from a pixel to which the on signal is supplied. This operation is performed by sequentially switching driving lines. Consequently, a radiation image is generated.

As a method for achieving moving image capturing at a high frame rate in such a radiation imaging apparatus, a binning process for combining a plurality of pixels into a single pixel is described. The publication of Japanese Patent Application Laid-Open No. 2020-073015 also describes the binning process as a known technique. In the binning process, for example, a driving circuit simultaneously applies on signals to driving lines in first and second rows and thereby can simultaneously close switch elements of pixels placed in the first and second rows and collectively transfer pixel signals in two rows to a signal line. This process is termed analog binning and enables data of two rows to be read at a time. Thus, it is possible to reduce the time required for reading to half, and it is possible to achieve a frame rate higher than in a case where the analog binning is not performed. A radiation image read by the analog binning is an image reduced only in the column direction. Thus, digital binning for adding values to or averaging the values of pixels in the row direction is performed on this image, whereby it is possible to generate an image in which the reduction ratios in the column direction and the row direction match each other.

However, it is found that if this binning, particularly the analog binning, is performed, line-like noise (hereinafter, "line noise") is visible in the row direction, depending on the state of the driving circuit or each driving line when reading is performed. This causes an issue where, if an attempt is made to achieve a high frame rate by performing the analog binning in two or more rows by a conventional method and reading the rows, line noise is visible, and an image unsuitable for a diagnosis image is generated.

### SUMMARY

Accordingly, in view of the above issue, embodiments of the present disclosure are directed to providing a radiation imaging apparatus capable or maintaining a high frame rate while reducing the visibility of line noise due to analog binning reading, and a radiation imaging system.

According to embodiments of the present disclosure, a radiation imaging apparatus includes a plurality of pixels, each including a conversion element configured to convert radiation or light into a charge and a switch element configured to control an output of the charge from the conversion element, is arranged in a matrix, a driving unit configured to output driving signals that drive the switch elements, a plurality of driving lines connecting the driving unit and the pixels with respect to each row and configured to supply driving signals output from the driving unit to the switch elements, and a reading unit configured to read a charge from a pixel to which a driving signal is supplied, and generate an image data signal, wherein after emission of radiation, the driving unit outputs a first driving signal to a first driving line among the plurality of driving lines and outputs a second driving signal to a second driving line adjacent to the first driving line by shifting timings to reduce line noise along the driving lines, and wherein the reading unit generates an image data signal by totaling a first charge read from a pixel by the driving unit outputting the first driving signal to the first driving line and a second charge read from a pixel by outputting the second driving signal to the second driving line.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a configuration of a radiation imaging system according to the present disclosure.

FIG. 2 is a diagram illustrating an example of a configuration of a radiation imaging apparatus according to the present disclosure.

FIG. 3 is a diagram illustrating an example of a cross-sectional structure of a pixel according to the present disclosure.

FIG. 4 is a diagram illustrating an example of a radiation imaging system according to a first embodiment of the present disclosure.

FIG. 5 is a diagram illustrating an example of a radiation imaging system according to a second embodiment of the present disclosure.

FIG. 6 is a diagram illustrating an example of a radiation imaging system according to a third embodiment of the present disclosure.

FIG. 7 is a sequence diagram of an even-number-of-rows binning reading process of the radiation imaging system according to the present disclosure.

FIG. 8 is a sequence diagram of an odd-number-of-rows binning reading process of the radiation imaging system according to the present disclosure.

FIG. 9 is a diagram illustrating another example of the radiation imaging system according to the first embodiment of the present disclosure.

FIG. 10 is a diagram illustrating another example of the radiation imaging system according to the second embodiment of the present disclosure.

FIG. 11 is a diagram illustrating another example of the radiation imaging system according to the third embodiment of the present disclosure.

FIG. 12 is a diagram illustrating an example of a driving circuit of the radiation imaging system according to the present disclosure.

FIG. 13 is a diagram illustrating an example of an operation of a control circuit in the example of the radiation imaging system according to the first embodiment of the present disclosure.

FIG. 14 is a diagram illustrating an example of the radiation imaging system according to the present disclosure.

### DESCRIPTION OF THE EMBODIMENTS

Embodiments will be described in detail below with reference to the attached drawings. The following embodiments do not limit the disclosure according to the appended claims. Although a plurality of features is described in the embodiments, not all the plurality of features is essential for the disclosure, and the plurality of features may be optionally combined together. Further, in the attached drawings, the same or similar components are designated by the same reference numbers, and are not redundantly described.

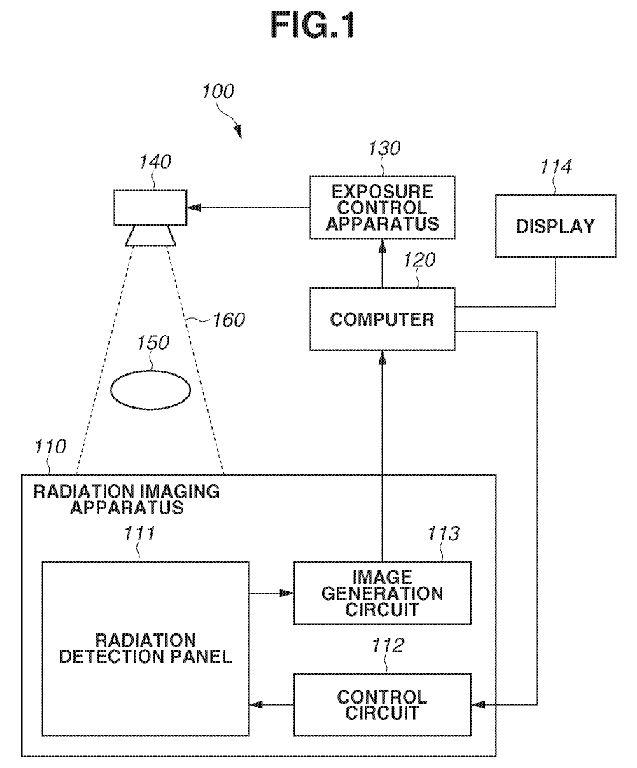

FIG. 1 illustrates an example of the configuration of a radiation imaging system 100 according to first to third embodiments of the present disclosure. The radiation imaging system 100 is configured to electrically capture an optical image formed by radiation, thereby obtaining an electrical radiation image. The radiation is typically an X-ray, but may be an α-ray, a β-ray, a γ-ray, or the like. For example, the radiation imaging system 100 includes a radiation imaging apparatus 110, a computer 120 as a control apparatus, a display 114, an exposure control apparatus 130, and a radiation generating apparatus 140.

According to an exposure command (an emission command) from the exposure control apparatus 130, the radiation generating apparatus 140 starts emitting radiation 160. The radiation 160 emitted from the radiation generating apparatus 140 passes through an object 150 and is incident on the radiation imaging apparatus 110. According to a stop command from the exposure control apparatus 130, the radiation generating apparatus 140 also stops emitting the radiation 160.

The radiation imaging apparatus 110 includes a radiation detection panel 111, a control circuit 112, and an image generation circuit 113 as an image signal generation unit. The radiation detection panel 111 generates an image data signal according to the radiation 160 incident on the radiation imaging apparatus 110. The image data signal is data for generating a radiation image and is a data signal based on a charge generated by a conversion element. The control circuit 112 controls the operation of the radiation detection panel 111. For example, based on an image data signal obtained from the radiation detection panel 111, the control circuit 112 generates a stop signal for stopping the emission of the radiation 160 from the radiation generating apparatus 140. The stop signal is supplied to the exposure control apparatus 130. In response to the stop signal, the exposure control apparatus 130 sends a stop command to the radiation generating apparatus 140. For example, the control circuit 112 is composed of a programmable logic device (PLD) such as a field-programmable gate array (FPGA) or the like. The control circuit 112 may also be composed of a dedicated circuit such as an application-specific integrated circuit (ASIC). Alternatively, the control circuit 112 may be composed of the combination of a general-purpose processing circuit such as a processor and a storage circuit such as a memory. In this case, the function of the control circuit 112 may be achieved by the general-purpose processing circuit executing a program stored in the storage circuit.

The image generation circuit 113 stores an image data signal supplied from the radiation detection panel 111 in a memory and generates a radiation image signal based on this signal. The details of the method for generating the radiation image signal will be described below. The image generation circuit 113 transmits the generated radiation image signal to the computer 120. The computer 120 as the control apparatus processes the received image signal.

The computer 120 includes a control unit that controls the radiation imaging apparatus 110 and the exposure control apparatus 130, a reception unit that receives an image signal from the radiation imaging apparatus 110, and a signal processing unit that processes the image signal obtained by the radiation imaging apparatus 110. Similarly to the control circuit 112, each of the control unit, the reception unit, and the signal processing unit may be composed of a dedicated circuit, or may be composed of the combination of a general-purpose processing circuit and a storage circuit. As an example, the exposure control apparatus 130 includes an exposure switch. If a user turns on the exposure switch, the exposure control apparatus 130 sends an exposure command to the radiation generating apparatus 140 and also sends a start notification indicating the start of the emission of the radiation 160 to the computer 120. In response to the start notification, the computer 120 having received the start notification notifies the control circuit 112 in the radiation imaging apparatus 110 of the start of the emission of the radiation 160.

In a case where the exposure control apparatus 130 and the computer 120 are not synchronously connected together, the radiation detection panel 111 may continue an image reading operation and detect the start of the emission of the radiation 160 based on the output value of an image signal.

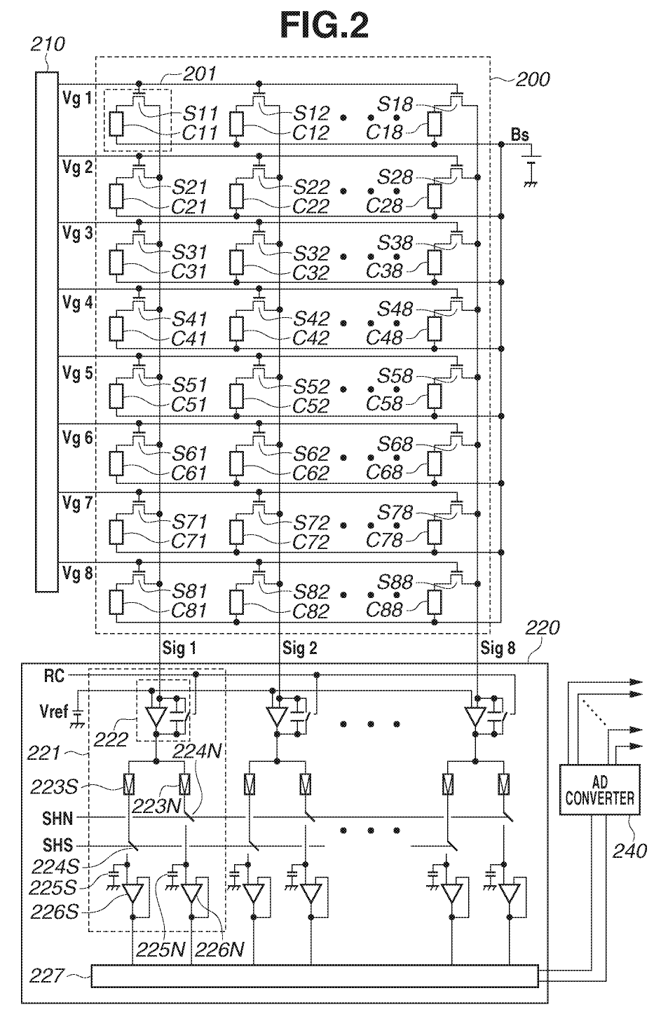

FIG. 2 illustrates an example of the configuration of the radiation detection panel 111. For example, the radiation detection panel 111 includes a pixel array 200, a driving circuit 210 as a driving unit, a reading circuit 220 as a reading unit, and an analog-to-digital (AD) converter 240. The driving circuit 210 and the reading circuit 220 function as peripheral circuits of the pixel array 200. For example, the pixel array 200 includes a plurality of pixels 201 disposed in a matrix (an array), a plurality of driving lines Vg(1) to Vg(8), a plurality of signal lines Sig1 to Sig8, and a bias line Bs. The driving lines Vg(1) to Vg(8) connect the driving circuit 210 as the driving unit and the pixels 201 with respect to each row and supply driving signals output from the driving circuit 210 to switch elements (switch elements of the pixels 201). In FIG. 2, for illustrative purposes, the pixel array 200 is composed of pixels 201 in 8 rows × 8 columns. However, actually, more pixels 201 can be placed. As an example, the radiation detection panel 111 has a size of 17 inches and includes pixels 201 in about 3000 rows × about 3000 columns. Each pixel 201 is composed of a conversion element and an output switch element.

The pixel array 200 includes a plurality of conversion elements C11 to C88 and a plurality of output switch elements S11 to S88. In the following description, the conversion elements C11 to C88 are collectively referred to as a "conversion element C". The description of the conversion element C applies to each of the conversion elements C11 to C88. Similarly, the output switch elements S11 to S88, the driving lines Vg(1) to Vg(8), and the signal lines Sig1 to Sig8 are collectively referred to as an "output switch element S", a "driving line Vg", and a "signal line Sig", respectively. The rows of the pixel array 200 are referred to as a "first row" to an "eighth row" in order from the upper side of FIG. 2. The columns of the pixel array 200 are referred to as a "first column" to an "eighth column" in order from the left side of FIG. 2. Each pixel 201 is composed of the combination of a single conversion element C and a single output switch element S. For example, the pixel 201 in the first row and the second column is composed of the combination of the conversion element C12 and the output switch element S12.

In each pixel 201, the conversion element C converts incident radiation into a charge signal, and the output switch element S is connected between the conversion element C and the signal line Sig corresponding to the conversion element C. For example, the output switch elements S11, S21, S31, S41, S51, S61, S71, and S81 are connected between the plurality of conversion elements C11, C21, C31, C41, C51, C61, C71, and C81 and the signal line Sig1. If the output switch element S is turned on, the conversion element C and the signal line Sig enter a conducting state, and a charge signal obtained by the conversion element C (e.g., a charge accumulated in the conversion element C) is transferred to the signal line Sig. For example, the conversion element C may be a metal-insulator-semiconductor (MIS) photodiode placed on an insulating substrate such as a glass substrate or the like and having amorphous silicon as a main material. Alternatively, the conversion element C may be a PIN photodiode. The conversion element C may be configured as a direct type that directly converts radiation into a charge, or may be configured as an indirect type that converts radiation into light and then detects the light. In the indirect type, a scintillator may be shared by the plurality of pixels 201.

For example, the output switch element S includes a transistor such as a thin-film transistor (TFT) having a control terminal (a gate) and two main terminals (a source and a drain) or the like. The conversion element C has two main electrodes. One of the main electrodes of the conversion element C is connected to one of the two main terminals of the output switch element S, and the other main electrode of the conversion element is connected to a bias power supply Vs via the common bias line Bs. The bias power supply Vs generates a bias voltage.

The control terminal of the output switch element S of each of the pixels 201 in the first row is connected to the driving line Vg(1). The control terminal of the output switch element S of each of the pixels 201 in the second row is connected to the driving line Vg(2). The same applies to the third to eighth rows.

According to a control signal supplied from the control circuit 112, the driving circuit 210 supplies a driving signal to the control terminal of the output switch element S of each pixel 201 connected to each driving line Vg via the driving line Vg. The control signal includes an on signal (a high level in the following description) for turning on the output switch element S, and an off signal (a low level in the following description) for turning off the output switch element S. For example, the driving circuit 210 includes a shift register. According to a control signal (e.g., a clock signal) supplied from the control circuit 112, the shift register performs a shift operation.

The reading circuit 220 amplifies and reads a charge signal that is obtained by the conversion element C and appears on the signal line Sig. The reading circuit 220 includes a single amplification circuit 221 with respect to each signal line Sig. Since the pixel array 200 includes the eight signal lines Sig in the example of FIG. 2, the reading circuit 220 includes eight amplification circuits 221. For example, the amplification circuit 221 includes an integrating amplifier 222, a low-pass filter (LPF) circuit 223S, an LPF circuit 223N, a signal sample hold switch element 224S, and a noise sample hold switch element 224N. The amplification circuit 221 further includes a capacitor 225S, a capacitor 225N, a buffer circuit 226S, and a buffer circuit 226N. The signal sample hold switch element 224S and the capacitor 225S form a signal sample hold circuit, and the noise sample hold switch element 224N and the capacitor 225N form a noise sample hold circuit. For example, the integrating amplifier 222 includes an operational amplifier, and an integrating capacitor and a reset switch connected in parallel between an inverting input terminal and an output terminal of the operational amplifier. To a non-inverting input terminal of the operational amplifier, a reference voltage is supplied from a reference power supply Vref. If the reset switch is turned on according to a control signal RC (a reset pulse) supplied from the control circuit 112, the integrating capacitor is reset, and the potential of the signal line Sig is also reset to a reference potential. The LPF circuits 223S and 223N remove noise from a signal from the integrating amplifier 222 based on set filter values. The sample hold circuits sample-hold signals from the LPF circuits 223S and 223N. The turning on and off of the signal sample hold switch element 224S and the noise sample hold switch element 224N forming the sample hold circuits are controlled by a control signal SHS and a control signal SHN, respectively, supplied from the control circuit 112. The buffer circuits 226S and 226N buffer (convert the impedances of) signals from the sample hold circuits and output the signals.

The reading circuit 220 also includes a multiplexer 227 that selects and outputs signals from the plurality of amplification circuits 221 in a predetermined order. For example, the multiplexer 227 includes a shift register. According to a control signal (e.g., a clock signal) supplied from the control circuit 112, the shift register performs a shift operation. By the shift operation, the plurality of amplification circuits 221 is selected in order, and the outputs of the signal sample hold circuits and the outputs of the noise sample hold circuits in the selected amplification circuits 221 are output.

The AD converter 240 converts the difference between two analog signals output from the multiplexer 227 into a digital signal. The output of the AD converter 240, i.e., an image signal, is transmitted to the computer 120.

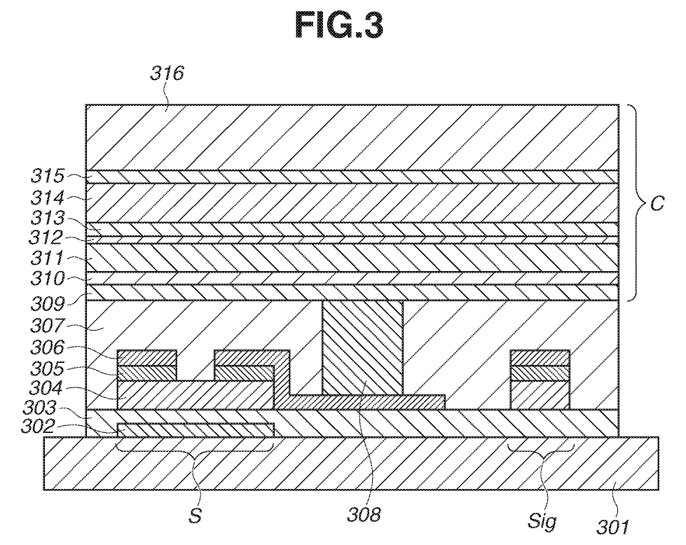

FIG. 3 schematically illustrates an example of the cross-sectional structure of a single pixel 201. The pixel 201 is formed on an insulating substrate 301 such as a glass substrate or the like. The pixel 201 includes a conductive layer 302, an insulating layer 303, a semiconductor layer 304, an impurity semiconductor layer 305, and a conductive layer 306 on the insulating substrate 301. The conductive layer 302 forms the gate of the transistor (e.g., a TFT) included in the output switch element S. The insulating layer 303 is placed to cover the conductive layer 302. The semiconductor layer 304 is placed through the insulating layer 303 on a portion of the conductive layer 302 that forms the gate. The impurity semiconductor layer 305 is placed on the semiconductor layer 304 to form the two main terminals (the source and the drain) of the transistor included in the switch element S. The conductive layer 306 forms wiring patterns connected to the two main terminals (the source and the drain) of the transistor included in the switch element S. A part of the conductive layer 306 forms the signal line Sig, and another part of the conductive layer 306 forms a wiring pattern for connecting the conversion element C and the output switch element S.

The pixel 201 further includes an interlayer insulating film 307 that covers the insulating layer 303 and the conductive layer 306.

In the interlayer insulating film 307, a contact plug 308 for connecting to the conductive layer 306 (the output switch element S) is provided. The pixel 201 further includes a conductive layer 309, an insulating layer 310, a semiconductor layer 311, an impurity semiconductor layer 312, a conductive layer 313, a protection layer 314, an adhesive layer 315, and a scintillator 316 in this order on the interlayer insulating film 307. These layers form the conversion element C of the indirect type. The conductive layers 309 and 313 form a lower electrode and an upper electrode, respectively, of a photoelectric conversion element included in the conversion element C. For example, the conductive layer 313 is composed of a transparent material. The conductive layer 309, the insulating layer 310, the semiconductor layer 311, the impurity semiconductor layer 312, and the conductive layer 313 form an MIS sensor as the photoelectric conversion element.

For example, the impurity semiconductor layer 312 is formed of an n-type impurity semiconductor layer. For example, the scintillator 316 is composed of a gadolinium material or a cesium iodide (CsI) material and converts radiation into light.

Instead of the above example, the conversion element C may be configured as the conversion element C of the direct type that directly converts incident radiation into a charge signal. Examples of the conversion element C of the direct type include conversion elements having amorphous selenium, gallium arsenic, gallium phosphide, lead iodide, mercury iodide, cadmium telluride (CdTe), cadmium zinc telluride (CdZnTe), and the like as main materials. The conversion element C is not limited to the MIS type, and for example, may be a PN-type or PIN-type photodiode.

In the example illustrated in FIG. 3, in orthographic projection (a planar view) onto a surface on which the pixel array 200 is formed, each of the plurality of signal lines Sig overlaps a part of the conversion element C. This configuration has the advantage that the area of the conversion element C of each pixel 201 can be large. However, on the other hand, this configuration has the disadvantage that capacitive coupling between the signal line Sig and the conversion element C becomes large.

### First Embodiment

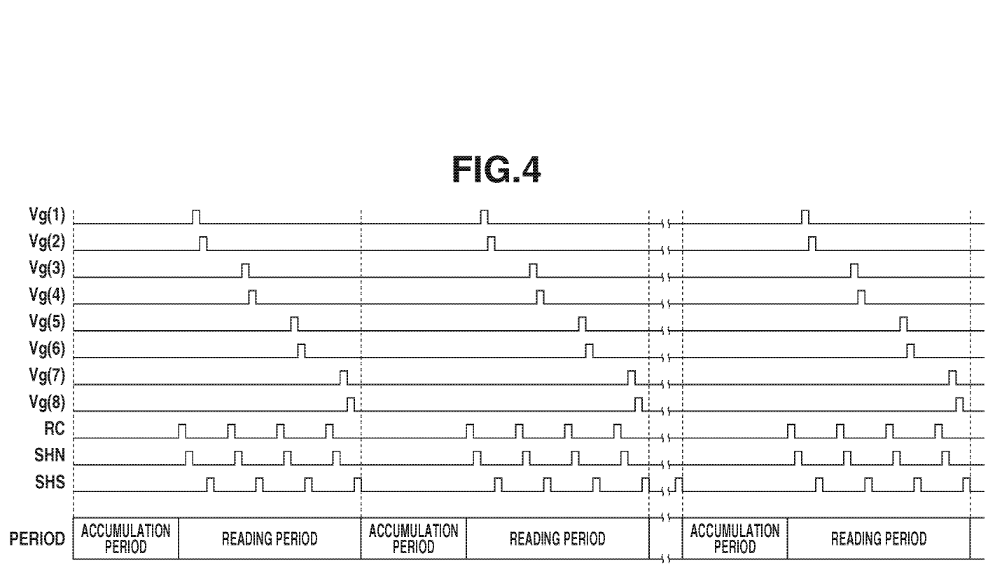

In a first embodiment, with reference to FIG. 4, an example of the operation of the radiation imaging system 100 is described. The operation of the radiation imaging system 100 is controlled by the computer 120. The operation of the radiation imaging apparatus 110 is controlled by the control circuit 112 under control of the computer 120.

Regarding radiation in FIG. 4, "Vg(1)" to "Vg(8)" in a timing chart indicate the levels of the driving signals supplied from the driving circuit 210 to the driving lines Vg1 to Vg8, respectively. An output switch element S connected to a driving line Vg to which the driving signal at a low level (an off signal) is supplied is off, and an output switch element S connected to a driving line Vg to which the driving signal at a high level (an on signal) is supplied is on. "RC" in FIG. 4 indicates the state of the control signal RC (the reset pulse) of the reading circuit 220. If the control signal RC in FIG. 4 is at a low level (an off signal), the reset switches are in off states. If the control signal RC in FIG. 4 is at a high level (an on signal), the reset switches are in on states. "SHS" in FIG. 4 indicates the level of a switch signal for the signal sample hold switch elements 224S of the signal sample hold circuits. "SHN" indicates the level of a switch signal for the noise sample hold switch elements 224N of the noise sample hold circuits. If the signal SHS or SHN is at a low level (an off signal), the signal sample hold switch elements 224S or the noise sample hold switch elements 224N are off. If the signal SHS or SHN is at a high level (an on signal), the signal sample hold switch elements 224S or the noise sample hold switch elements 224N are on.

FIG. 4 illustrates an example of control of an analog binning operation in two adjacent rows.

The control circuit 112 in the radiation imaging apparatus 110 receives an instruction to start a two-row binning operation from the computer 120, thereby starting control for two-row binning on the radiation detection panel 111. When the control circuit 112 starts the control for two-row binning, the control circuit 112 causes the radiation detection panel 111 to perform an accumulation operation while radiation is emitted. During an accumulation period, the control circuit 112 controls all of the control signals RC, SHS, and SHN to be at the low levels and also controls the driving circuit 210 to set the driving lines Vg(1) to Vg(8) to the low levels. Consequently, the radiation detection panel 111 accumulates charges in the conversion elements C of the pixels 201 for a predetermined period. Then, after the emission of the radiation, the radiation detection panel 111 enters a reading period. First, the control circuit 112 sets the control signal RC to the high level for a predetermined period. This achieves a reset operation for resetting the integrating capacitors in the amplification circuits 221 connected to the signal lines Sig1 to Sig8. Then, the control circuit 112 sets the control signal RC to the low level, thereby setting the reset switches to the off states. Then, the control circuit 112 controls the control signal SHN to be at the high level, thereby turning on the noise sample hold switch elements 224N of the noise sample hold circuits connected to the signal lines Sig1 to Sig8. Consequently, the control circuit 112 performs a noise sample hold operation for sample-holding noise signals when the reset operation is performed in the integrating amplifiers 222 connected to the signal lines Sig1 to Sig8. After a predetermined period elapses, the control circuit 112 returns the control signal SHN to the low level. Then, the control circuit 112 controls the driving circuit 210 to set the driving line Vg(1) to the high level. Consequently, the transfer of the charges accumulated in the conversion elements C of the pixels 201 connected to the first row of the pixel array 200 to the signal lines Sig1 to Sig8 is started. After a predetermined period elapses, the control circuit 112 controls the driving circuit 210 to return the driving line Vg(1) to the low level and simultaneously set the driving line Vg(2) to the high level. Consequently, the transfer of the charges accumulated in the conversion elements C of the pixels 201 connected to the first row of the pixel array 200 to the signal lines Sig1 to Sig8 is stopped. Simultaneously, the transfer of the charges accumulated in the conversion elements C of the pixels 201 connected to the second row adjacent to the first row to the signal lines Sig1 to Sig8 is started. The reason why line-like noise observed in the row direction is visible when analog binning is performed is that the high levels are simultaneously given to a plurality of adjacent driving lines, thereby closing switches of pixels connected to the driving lines. Accordingly, in the following embodiments including the present embodiment, control is performed to shift the periods when the high levels are given to avoid simultaneously giving the high levels to adjacent driving lines when analog binning is performed.

After a predetermined period elapses, the control circuit 112 controls the driving circuit 210 to return the driving line Vg(2) to the low level, thereby returning the driving line Vg(2) to the low level. Then, the control circuit 112 controls the control signal SHS to be at the high level, thereby turning on the signal sample hold switch elements 224S of the signal sample hold circuits connected to the signal lines Sig1 to Sig8. Consequently, the charges transferred from the conversion elements C of the pixels 201 connected to the first and second rows are amplified by the integrating amplifiers 222, and the control circuit 112 performs a signal sample hold operation on the charges in each of the signal lines Sig1 to Sig8. After a predetermined period elapses, the control circuit 112 returns the control signal SHS to the low level. This results in the state where electric signals based on the charges transferred from the conversion elements C of the pixels 201 connected to the first and second rows of the pixel array 200 are accumulated in the capacitors 225S of the amplification circuits 221 connected to the signal lines Sig1 to Sig8. This also results in the state where electric signals of the noise components of the integrating amplifiers 222 are accumulated in the capacitors 225N. Then, the control circuit 112 controls the reading circuit 220 to output the outputs of the signal sample hold circuits and the outputs of the noise sample hold circuits of the amplification circuits 221 connected to the signal lines Sig1 to Sig8 in order from the multiplexer 227. Consequently, the AD converter 240 converts the difference between the output of the signal sample hold circuit and the output of the noise sample hold circuit of each amplifier 221 from the multiplexer 227 into a digital signal and sequentially generates image data signals after the analog binning is performed on the pixels 201 in the first and second rows. As described above, in this example, image data signals are generated by totaling the charges read from the pixels 201 in the first and second rows.

Next, the control circuit 112 performs the reset operation for setting the control signal RC to the high level for a predetermined period and resetting the integrating capacitors in the amplification circuits 221 connected to the signal lines Sig1 to Sig8 again. Then, the control circuit 112 sets the control signal RC to the low level, thereby setting the reset switches to the off states. Then, the control circuit 112 controls the control signal SHN to be at the high level. Consequently, the control circuit 112 performs the noise sample hold operation in the integrating amplifiers 222 connected to the signal lines Sig1 to Sig8. After a predetermined period elapses, the control circuit 112 returns the control signal SHN to the low level. Then, the control circuit 112 controls the driving circuit 210 to perform control equivalent to the control previously performed on the driving lines Vg(1) and Vg(2) on the driving lines Vg(3) and Vg(4). That is, the control circuit 112 controls the driving circuit 210 to set the driving line Vg(3) to the high level for a predetermined period, return the driving line Vg(3) to the low level, simultaneously set the driving line Vg(4) to the high level, and after a predetermined period elapses, return the driving line Vg(4) to the low level. Consequently, the charges accumulated in the conversion elements C of the pixels 201 in the third and fourth rows are sequentially transferred to the signal lines Sig1 to Sig8 connected to the pixels 201. Further, the control circuit 112 controls the driving circuit 210 to return the driving line Vg(4) to the low level, thereby returning the driving line Vg(4) to the low level. Then, the control circuit 112 controls the control signal SHS to be at the high level, thereby turning on the signal sample hold switch elements 224S of the signal sample hold circuits connected to the signal lines Sig1 to Sig8. Consequently, the control circuit 112 performs the signal sample hold operation on the transferred charges accumulated in the conversion elements C of the pixels 201 in the third and fourth rows with respect to each of the signal lines Sig1 to Sig8. After a predetermined period elapses, the control circuit 112 returns the control signal SHS to the low level. This results in the state where electric signals based on the charges transferred from the conversion elements C of the pixels 201 connected to the third and fourth rows are accumulated in the capacitors 225S of the amplification circuits 221 connected to the signal lines Sig1 to Sig8. This also results in the state where electric signals of the noise components of the integrating amplifiers 222 are accumulated in the capacitors 225N. Then, the control circuit 112 controls the reading circuit 220 to output the outputs of the signal sample hold circuits and the outputs of the noise sample hold circuits of the amplification circuits 221 connected to the signal lines Sig1 to Sig8 in order from the multiplexer 227. Consequently, the AD converter 240 converts the difference between the output of the signal sample hold circuit and the output of the noise sample hold circuit of each amplifier 221 from the multiplexer 227 into a digital signal and sequentially generates image data signals after the analog binning is performed on the pixels 201 in the third and fourth rows.

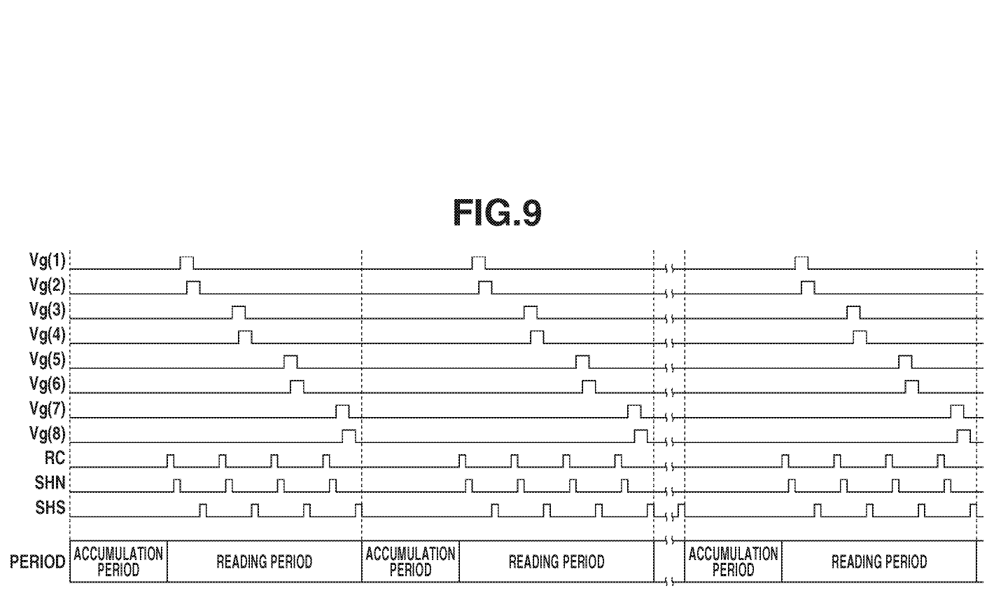

After that, also in the driving lines Vg(5) to Vg(8), similar control is performed on the driving lines Vg(5) and Vg(6) as a set and the driving lines Vg(7) and Vg(8) as a set, whereby it is possible to generate an image obtained by performing analog binning on two pixels in the column direction. Consequently, the reading period ends. The image generation circuit 113 may perform a digital binning process in the row direction for the radiation detection panel 111 to match the reduction ratios in the row direction and the column direction, or a known image correction process on image data generated from the radiation image data signals. Then, the image generation circuit 113 transmits a generated image signal to the computer 120, whereby it is possible to display a radiation image on the display 114 connected to the computer 120. After the radiation detection panel 111 ends the reading period, the control circuit 112 controls the radiation detection panel 111 again, and the radiation detection panel 111 enters an accumulation period again and accumulates charges in the conversion elements C of the pixels 201. Then, the radiation detection panel 111 enters a reading period and performs the above series of reading processes. It is possible to achieve the provision of a moving image by repeating this processing. Such analog binning is performed, whereby, when an n-th row and an (n+1)-th row as adjacent rows to be subjected to analog binning are read, the high levels are not simultaneously given to driving lines Vg(n) and Vg(n+1). Thus, it is possible to reduce the deterioration of line noise due to analog binning. On the other hand, the reading time increases compared to a control method for simultaneously giving the high levels to the driving lines Vg(n) and Vg(n+1), but the numbers of times a sample hold process and an AD conversion process are performed are not different from a conventional control method for analog binning. Thus, the increase in the reading time is minimized. This can achieve a high frame rate while reducing the deterioration of line noise due to analog binning. In the present embodiment, to minimize an increase in the reading time, in the driving lines Vg(1) and Vg(2) as adjacent rows to be subjected to analog binning, at the timing when the driving line Vg(1) is controlled to change from the high level to the low level, the driving line Vg(2) is simultaneously controlled to change from the low level to the high level. That is, the outputs of the driving signals to the driving lines Vg(1) and Vg(2) are controlled so that the falling edge of the driving signal to the driving line Vg(1) and the rising edge of the driving signal to the driving line Vg(2) coincide with each other. However, even if the reading time increases, but if the reading catches up with the achieved frame rate, the driving line Vg(1) may be controlled to change from the high level to the low level, and after a predetermined period elapses, the driving line Vg(2) may be controlled to change from the low level to the high level. Alternatively, as illustrated in FIG. 9, for example, before the driving line Vg(1) is controlled to change from the high level to the low level, the driving line Vg(2) may be controlled to change from the low level to the high level, thereby overlapping parts of the high level periods of the driving lines Vg in adjacent rows. The overlap of the high level periods of the driving lines Vg has the advantage that it is possible to ensure a long time for the transfer time of charge signals from the output switch elements S.

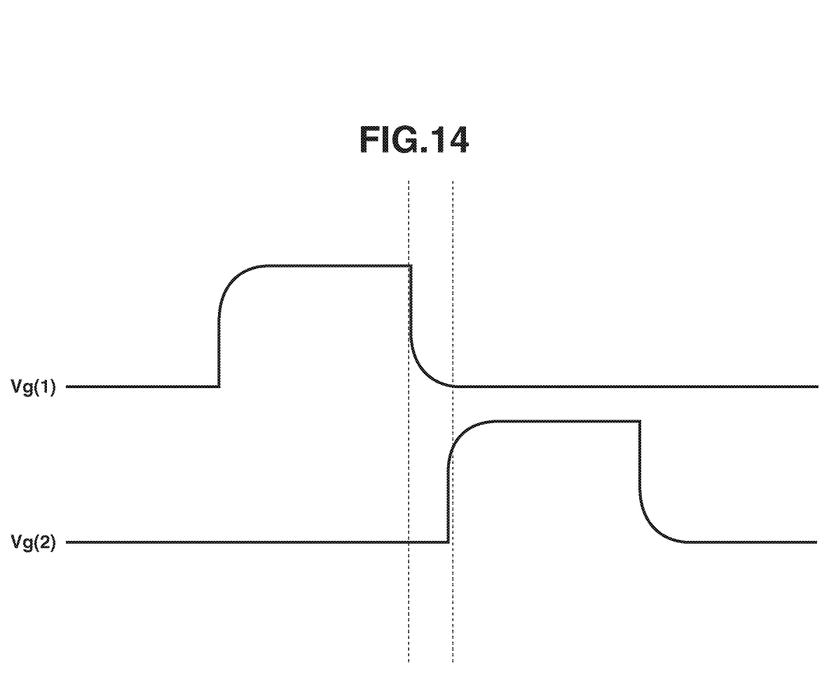

Although in the description with reference to FIG. 4, the waveform of the driving signal output from the driving circuit 210 to each driving line Vg is a rectangle, actually, the waveform of the driving signal is such that the rising edge and the falling edge of the driving signal are blunt depending on the configuration of the driving circuit 210. FIG. 14 illustrates a case where, for example, the falling edge of the driving signal (a first driving signal) output to the driving line Vg(1) and the rising edge of the driving signal (a second driving signal) output to the driving line Vg(2) are caused to coincide with each other in this case. As illustrated in FIG. 14, if the bluntness (tailing) of the falling edge of the first driving signal and the rising edge of the second driving signal overlap each other, it is determined that the falling edge of the first driving signal and the rising edge of the second driving signal coincide with each other. Also in this case, it is possible to achieve a high frame rate while reducing the deterioration of line noise due to analog binning.

### Second Embodiment

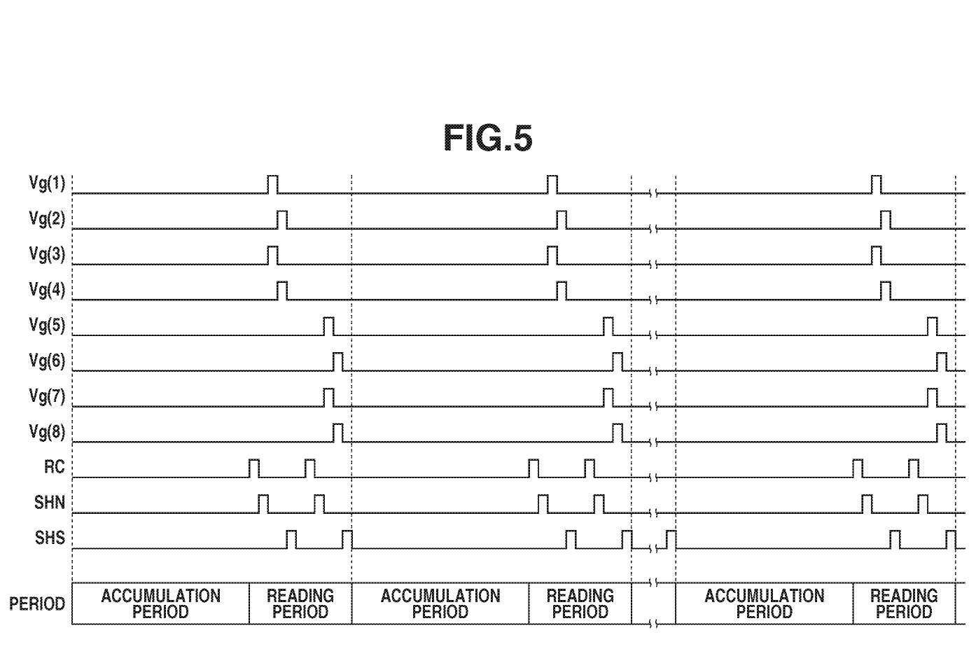

Next, in a second embodiment, with reference to FIG. 5, an example of control of an analog binning operation in four adjacent rows is illustrated.

The control circuit 112 in the radiation imaging apparatus 110 receives an instruction to start a four-row binning operation from the computer 120, thereby starting control for four-row binning on the radiation detection panel 111. The differences between the first and second embodiments are described here. When the control circuit 112 starts the control for four-row binning, the radiation detection panel 111 enters an accumulation period and accumulates charges in the conversion elements C of the pixels 201 for a predetermined period. An operation performed during this accumulation period is processing equivalent to that in the first embodiment. Then, the radiation detection panel 111 enters a reading period. First, the control circuit 112 sets the control signal RC to the high level. Consequently, the control circuit 112 performs a reset operation for resetting the integrating capacitors in the amplification circuits 221 connected to the signal lines Sig1 to Sig8. Then, the control circuit 112 sets the control signal RC to the low level, thereby setting the reset switches to the off states. Then, the control circuit 112 controls the control signal SHN to be at the high level, thereby turning on the noise sample hold switch elements 224N of the noise sample hold circuits connected to the signal lines Sig1 to Sig8.

Consequently, the control circuit 112 performs a noise sample hold operation in the integrating amplifiers 222 connected to the signal lines Sig1 to Sig8. After a predetermined period elapses, the control circuit 112 returns the control signal SHN to the low level. Then, the control circuit 112 controls the driving circuit 210 to set the driving lines Vg(1) and Vg(3) to the high levels. Consequently, the transfer of the charges accumulated in the conversion elements C of the pixels 201 connected to the first and third rows of the pixel array 200 to the signal lines Sig1 to Sig8 is started. After a predetermined period elapses, the control circuit 112 controls the driving circuit 210 to return the driving lines Vg(1) and Vg(3) to the low levels and simultaneously set the driving lines Vg(2) and Vg(4) to the high levels. Consequently, the transfer of the charges accumulated in the conversion elements C of the pixels 201 connected to the first and third rows to the signal lines Sig1 to Sig8 is stopped. Simultaneously, the transfer of the charges accumulated in the conversion elements C of the pixels 201 connected to the second and fourth rows adjacent to the first and third rows to the signal lines Sig1 to Sig8 is started. After a predetermined period elapses, the control circuit 112 controls the driving circuit 210 to return the driving lines Vg(2) and Vg(4) to the low levels, thereby returning the driving lines Vg(2) and Vg(4) to the low levels. Then, the control circuit 112 controls the control signal SHS to be at the high level, thereby turning on the signal sample hold switch elements 224S of the signal sample hold circuits connected to the signal lines Sig1 to Sig8. Then, the control circuit 112 performs a signal sample hold operation on the charges transferred from the conversion elements C of the pixels 201 connected to the first to fourth rows in each of the signal lines Sig1 to Sig8. After a predetermined period elapses, the control circuit 112 returns the control signal SHS to the low level. This results in the state where electric signals based on the charges transferred from the conversion elements C of the conversion pixels 201 connected to the first to fourth rows are accumulated in the capacitors 225S of the amplification circuits 221 connected to the signal lines Sig1 to Sig8. This also results in the state where electric signals of the noise components of the integrating amplifiers 222 are accumulated in the capacitors 225N. Then, the control circuit 112 controls the reading circuit 220 to output the outputs of the signal sample hold circuits and the outputs of the noise sample hold circuits of the amplification circuits 221 connected to the signal lines Sig1 to Sig8 in order from the multiplexer 227. Consequently, the AD converter 240 converts the difference between the output of the signal sample hold circuit and the output of the noise sample hold circuit of each amplifier 221 from the multiplexer 227 into a digital signal and sequentially generates image signals after the analog binning is performed on the pixels 201 in the first to fourth rows.

Next, the control circuit 112 performs the reset operation for setting the control signal RC to the high level for a predetermined period and resetting the integrating capacitors in the amplification circuits 221 connected to the signal lines Sig1 to Sig8 again. Then, the control circuit 112 sets the control signal RC to the low level, thereby setting the reset switches to the off states. Then, the control circuit 112 controls the control signal SHN to be at the high level. Consequently, the control circuit 112 performs the noise sample hold operation in the integrating amplifiers 222 connected to the signal lines Sig1 to Sig8. After a predetermined period elapses, the control circuit 112 returns the control signal SHN to the low level. Then, the control circuit 112 controls the driving circuit 210 to perform control equivalent to the control previously performed on the driving lines Vg(1) to Vg(4) on the driving lines Vg(5) to Vg(8). That is, the control circuit 112 controls the driving circuit 210 to set the driving lines Vg(5) and Vg(7) to the high levels for a predetermined period, return the driving lines Vg(5) and Vg(7) to the low levels, simultaneously set the driving lines Vg(6) and Vg(8) to the high levels, and after a predetermined period elapses, return the driving lines Vg(6) and Vg(8) to the low levels. Consequently, the charges accumulated in the conversion elements C of the pixels 201 in the fifth to eighth rows are sequentially transferred to the signal lines Sig1 to Sig8 connected to the pixels 201. Further, when the control circuit 112 controls the driving circuit 210 to return the driving lines Vg(6) and Vg(8) to the low levels, and after the driving lines Vg(6) and Vg(8) return to the low levels, the control circuit 112 controls the control signal SHS to be at the high level, thereby turning on the signal sample hold switch elements 224S of the signal sample hold circuits connected to the signal lines Sig1 to Sig8. Then, the control circuit 112 performs the signal sample hold operation on the transferred charges accumulated in the conversion elements C of the pixels 201 in the fifth to eighth rows with respect to each of the signal lines Sig1 to Sig8. After a predetermined period elapses, the control circuit 112 returns the control signal SHS to the low level. This results in the state where electric signals based on the charges transferred from the conversion elements C of the conversion pixels 201 connected to the fifth to eighth rows are accumulated in the capacitors 225S of the amplification circuits 221 connected to the signal lines Sig1 to Sig8. This also results in the state where electric signals of the noise components of the integrating amplifiers 222 are accumulated in the capacitors 225N. Then, the control circuit 112 controls the reading circuit 220 to output the outputs of the signal sample hold circuits and the outputs of the noise sample hold circuits of the amplification circuits 221 connected to the signal lines Sig1 to Sig8 in order from the multiplexer 227. Consequently, the AD converter 240 converts the difference between the output of the signal sample hold circuit and the output of the noise sample hold circuit of each amplifier 221 from the multiplexer 227 into a digital signal. Consequently, the AD converter 240 sequentially generates image signals after the analog binning is performed on the pixels 201 in the fifth to eighth rows. This can generate an image obtained by performing analog binning on four pixels in the column direction. Consequently, the reading period ends. After the radiation detection panel 111 ends the reading period, the control circuit 112 controls the radiation detection panel 111 again, and the radiation detection panel 111 enters an accumulation period again and accumulates charges in the conversion elements C of the pixels 201. Then, the radiation detection panel 111 enters a reading period and performs the above series of reading processes. It is possible to achieve the provision of a moving image by repeating this processing. Such row analog binning is performed, whereby, when an n-th row and an (n+1)-th row as adjacent rows to be subjected to analog binning are read, the high levels are not simultaneously given to driving lines Vg(n) and Vg(n+1). Thus, it is possible to reduce the deterioration of line noise due to analog binning. On the other hand, in a (4n)-th row and a (4n+2)-th row that are not adjacent to each other and a (4n+1)-th row and a (4n+3)-th row that are not adjacent to each other, the high levels are simultaneously to given to driving lines Vg(4n) and Vg(4n+2) and driving lines Vg(4n+1) and Vg(4n+3). Thus, the reading time is half of that in the first embodiment.

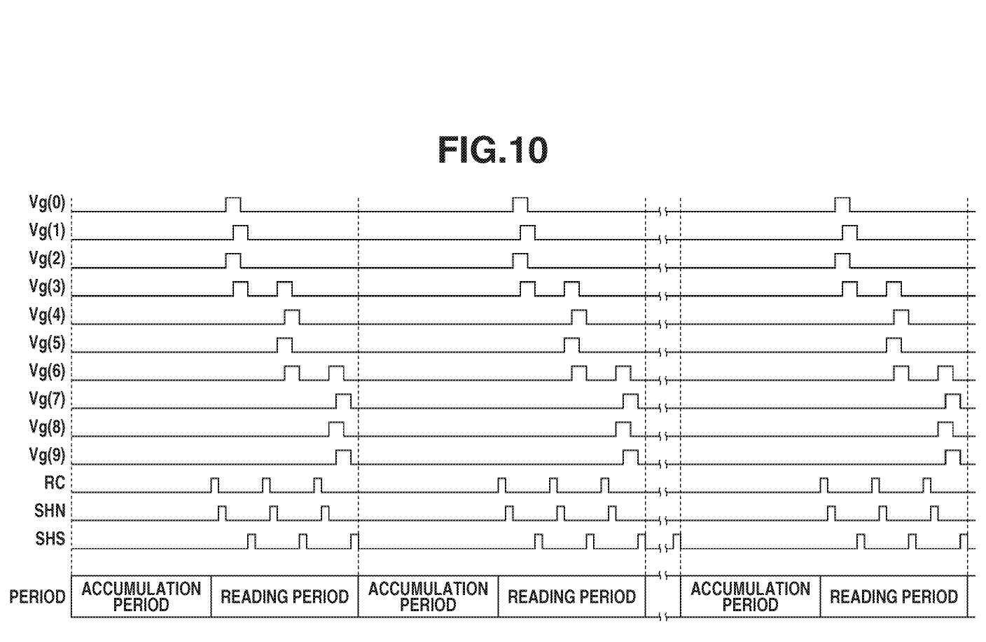

Also in the present embodiment, in the driving lines Vg(1) to Vg(4) as adjacent rows to be subjected to analog binning, at the timing when the driving lines Vg(1) and Vg(3) are controlled to change from the high levels to the low levels, the driving lines Vg(2) and Vg(4) are simultaneously controlled to change from the low levels to the high levels. This can prevent an increase in the reading time. However, even if the reading time increases, but if the reading catches up with the achieved frame rate, the driving lines Vg(1) and Vg(3) may be controlled to change from the high levels to the low levels, and after a predetermined period elapses, the driving lines Vg(2) and Vg(4) may be controlled to change from the low levels to the high levels. Alternatively, as illustrated in FIG. 10, for example, before the driving lines Vg(1) and Vg(3) are controlled to change from the high levels to the low levels, the driving lines Vg(2) and Vg(4) may be controlled to change from the low levels to the high levels, thereby overlapping parts of the high level periods of driving lines Vg in adjacent rows. The overlap of the high level periods of the driving lines Vg has the advantage that it is possible to ensure a long time for the transfer time of charge signals from the output switch elements S.

### Third Embodiment

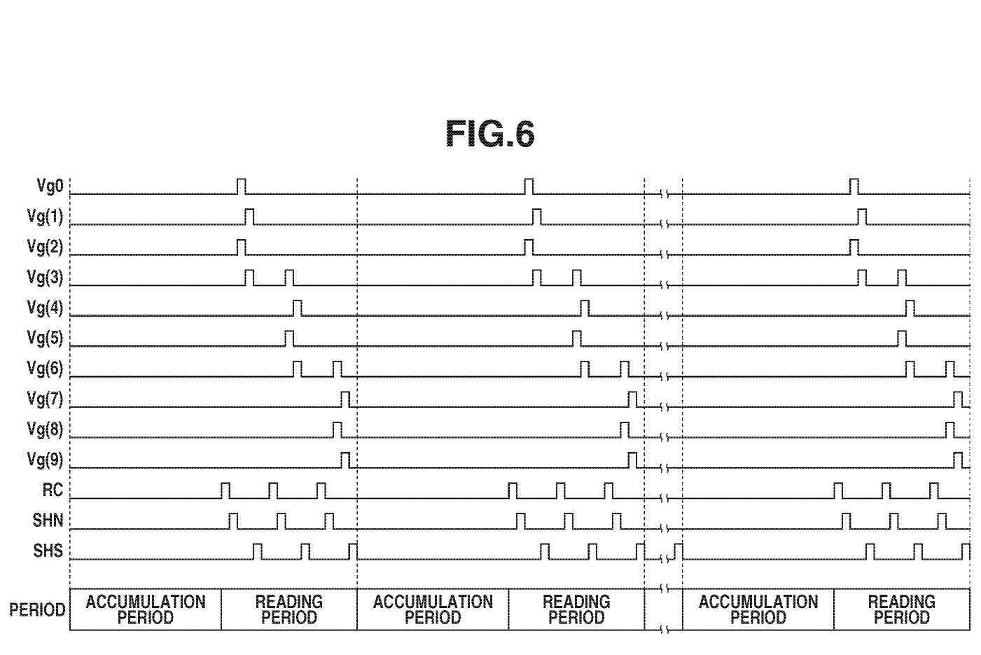

Next, in a third embodiment, with reference to FIG. 6, an example of control of an analog binning operation in three adjacent rows is illustrated. In this case, the description is given on the assumption that the pixel array 200 in FIG. 2 has a configuration including 9 rows and 8 columns by adding a row, the pixels 201 in the ninth row are connected to a driving line Vg(9) and further connected to the signal lines Sig1 to Sig8 in the respective columns, and the driving line Vg(9) is connected to the driving circuit 210. The description is given on the assumption that when three-row binning is performed, a driving line Vg(0) that is not used for a radiation image exists in the beginning row for the driving circuit 210. For example, the driving line Vg(0) is a dummy driving line to which conversion elements are not connected. Accordingly, "Vg(0)" and "Vg(9)" in a timing chart in FIG. 6 indicate the levels of the driving signals supplied to the driving line Vg(0) and the driving line Vg(9), to which the pixels 201 in the ninth row of the pixel array 200 are connected, respectively.

The control circuit 112 in the radiation imaging apparatus 110 receives an instruction to start a three-row binning operation from the computer 120, thereby starting control for three-row binning on the radiation detection panel 111. The differences between the second and third embodiments are described here. When the control circuit 112 starts the control for three-row binning, the radiation detection panel 111 enters an accumulation period and accumulates charges in the conversion elements C of the pixels 201 for a predetermined period. An operation performed during this accumulation period is processing equivalent to that in the second embodiment. Then, the radiation detection panel 111 enters a reading period. First, the control circuit 112 sets the control signal RC to the high level for a predetermined period. Consequently, the control circuit 112 performs a reset operation for resetting the integrating capacitors in the amplification circuits 221 connected to the signal lines Sig1 to Sig8. Then, the control circuit 112 sets the control signal RC to the low level, thereby setting the reset switches to the off states. Then, the control circuit 112 controls the control signal SHN to be at the high level, thereby turning on the noise sample hold switch elements 224N of the noise sample hold circuits connected to the signal lines Sig1 to Sig8. Consequently, the control circuit 112 performs a noise sample hold operation in the integrating amplifiers 222 connected to the signal lines Sig1 to Sig8. After a predetermined period elapses, the control circuit 112 returns the control signal SHN to the low level. Then, the control circuit 112 controls the driving circuit 210 to set the driving lines Vg(0) and Vg(2) to the high levels. Consequently, the transfer of the charges accumulated in the conversion elements C of the pixels 201 connected to the zeroth and second rows to the signal lines Sig1 to Sig8 is started. However, as described above, since the driving line Vg(0) is a dummy driving line that is not used for a radiation image, only the charges in the conversion elements C of the pixels 201 connected to the second row of the pixel array 200 are transferred at this time. After a predetermined period elapses, the control circuit 112 controls the driving circuit 210 to return the driving lines Vg(0) and Vg(2) to the low levels and simultaneously set the driving lines Vg(1) and Vg(3) to the high levels. Consequently, the transfer of the charges accumulated in the conversion elements C of the pixels 201 connected to the second row to the signal lines Sig1 to Sig8 is stopped. Simultaneously, the transfer of the charges accumulated in the conversion elements C of the pixels 201 connected to the first and third rows adjacent to the zeroth and second rows to the signal lines Sig1 to Sig8 is started. After a predetermined period elapses, the control circuit 112 controls the driving circuit 210 to return the driving lines Vg(1) and Vg(3) to the low levels, thereby returning the driving lines Vg(1) and Vg(3) to the low levels. Then, the control circuit 112 controls the control signal SHS to be at the high level, thereby turning on the signal sample hold switch elements 224S of the signal sample hold circuits connected to the signal lines Sig1 to Sig8. Then, the control circuit 112 performs a signal sample hold operation on the charges transferred from the conversion elements C of the pixels 201 connected to the first to third rows in each of the signal lines Sig1 to Sig8. After a predetermined period elapses, the control circuit 112 returns the control signal SHS to the low level. This results in the state where the charges transferred from the conversion elements C of the conversion pixels 201 connected to the first to third rows are accumulated in the capacitors 225S of the amplification circuits 221 connected to the signal lines Sig1 to Sig8, and charges of the noise components of the integrating amplifiers 222 are accumulated in the capacitors 225N. Then, the control circuit 112 controls the reading circuit 220 to output the outputs of the signal sample hold circuits and the outputs of the noise sample hold circuits of the amplification circuits 221 connected to the signal lines Sig1 to Sig8 in order from the multiplexer 227. Consequently, the AD converter 240 converts the difference between the output of the signal sample hold circuit and the output of the noise sample hold circuit of each amplifier 221 from the multiplexer 227 into a digital signal and sequentially generates image signals after the analog binning is performed on the pixels 201 in the first to third rows.

Next, the control circuit 112 performs the reset operation for setting the control signal RC to the high level for a predetermined period and resetting the integrating capacitors in the amplification circuits 221 connected to the signal lines Sig1 to Sig8 again. Then, the control circuit 112 sets the control signal RC to the low level, thereby setting the reset switches to the off states. Then, the control circuit 112 controls the control signal SHN to be at the high level. Consequently, the control circuit 112 performs the noise sample hold operation in the integrating amplifiers 222 connected to the signal lines Sig1 to Sig8. After a predetermined period elapses, the control circuit 112 returns the control signal SHN to the low level. Then, the control circuit 112 controls the driving circuit 210 to perform control equivalent to the control previously performed on the driving lines Vg(0) to Vg(3) on the driving lines Vg(3) to Vg(6). That is, the control circuit 112 controls the driving circuit 210 to set the driving lines Vg(3) and Vg(5) to the high levels for a predetermined period, return the driving lines Vg(3) and Vg(5) to the low levels, simultaneously set the driving lines Vg(4) and Vg(6) to the high levels, and after a predetermined period elapses, return the driving lines Vg(4) and Vg(6) to the low levels. Consequently, the charges accumulated in the conversion elements C of the pixels 201 connected to the third to sixth rows of the pixel array 200 are sequentially transferred to the signal lines Sig1 to Sig8 connected to the pixels 201. However, in the conversion elements C of the pixels 201 connected to the third row, the transfer of the charges is already completed by the above control for setting the driving lines Vg(1) and Vg(3) to the high levels. Thus, the charges transferred from the conversion elements C of the pixels 201 connected to the third row are very small relative to the charges transferred from the conversion elements C of the pixels 201 connected to the fourth to sixth rows. Thus, the charges transferred in this case can be considered equivalent to the charges accumulated in the conversion elements C of the pixels 201 connected to the fourth to sixth rows.

When the control circuit 112 controls the driving circuit 210 to return the driving lines Vg(4) and Vg(6) to the low levels, and after the driving lines Vg(4) and Vg(6) return to the low levels, the control circuit 112 controls the control signal SHS to be at the high level, thereby turning on the signal sample hold switch elements 224S of the signal sample hold circuits connected to the signal lines Sig1 to Sig8. Then, the control circuit 112 performs the signal sample hold operation on the transferred charges accumulated in the conversion elements C of the pixels 201 in the fourth to sixth rows with respect to each of the signal lines Sig1 to Sig8. After a predetermined period elapses, the control circuit 112 returns the control signal SHS to the low level. This results in the state where the charges transferred from the conversion elements C of the pixels 201 connected to the fourth to sixth rows are accumulated in the capacitors 225S of the amplification circuits 221 connected to the signal lines Sig1 to Sig8. This also results in the state where charges of the noise components of the integrating amplifier 222 are accumulated in the capacitors 225N. Then, the control circuit 112 controls the reading circuit 220 to output the outputs of the signal sample hold circuits and the outputs of the noise sample hold circuits of the amplification circuits 221 connected to the signal lines Sig1 to Sig8 in order from the multiplexer 227. Consequently, the AD converter 240 converts the difference between the output of the signal sample hold circuit and the output of the noise sample hold circuit of each amplification circuit 221 from the multiplexer 227 into a digital signal and sequentially generates image signals after the analog binning is performed on the pixels 201 in the fourth to sixth rows.

Then, the control circuit 112 performs the reset operation for setting the control signal RC to the high level for a predetermined period and resetting the integrating capacitors in the amplification circuits 221 connected to the signal lines Sig1 to Sig8 again. Then, the control circuit 112 controls the driving circuit 210 to perform control equivalent to the control previously performed on the driving lines Vg(3) to Vg(6) on the driving lines Vg(6) to Vg(9). Consequently, the charges accumulated in the conversion elements C of the pixels 201 connected to the sixth to ninth rows of the pixel array 200 are sequentially transferred to the signal lines Sig1 to Sig8 connected to the pixels 201. However, in the conversion elements C of the pixels 201 connected to the sixth row, the transfer of the charges is already completed by the above control for setting the driving lines Vg(4) and Vg(6) to the high levels. Thus, the charges transferred from the conversion elements C of the pixels 201 connected to the sixth row are very small relative to the charges transferred from the conversion elements C of the pixels 201 connected to the seventh to ninth rows. Thus, the charges transferred in this case can be considered equivalent to the charges accumulated in the conversion elements C of the pixels 201 connected to the seventh to ninth rows. Then, the control circuit 112 controls the control signal SHS to be at the high level, thereby turning on the signal sample hold switch elements 224S of the signal sample hold circuits connected to the signal lines Sig1 to Sig8. Then, the control circuit 112 performs the signal sample hold operation on the transferred charges accumulated in the conversion elements C of the pixels 201 in the seventh to ninth rows with respect to each of the signal lines Sig1 to Sig8. After a predetermined period elapses, the control circuit 112 returns the control signal SHS to the low level. This results in the state where electric signals transferred from the conversion elements C of the pixels 201 connected to the seventh to ninth rows are accumulated in the capacitors 225S of the amplification circuits 221 connected to the signal lines Sig1 to Sig8. This also results in the state where electric signals of the noise components of the integrating amplifiers 222 are accumulated in the capacitors 225N. Then, the control circuit 112 controls the reading circuit 220 to output the outputs of the signal sample hold circuits and the outputs of the noise sample hold circuits of the amplification circuits 221 connected to the signal lines Sig1 to Sig8 in order from the multiplexer 227. Consequently, the AD converter 240 converts the difference between the output of the signal sample hold circuit and the output of the noise sample hold circuit of each amplifier 221 from the multiplexer 227 into a digital signal and sequentially generates image signals after the analog binning is performed on the pixels 201 in the seventh to ninth rows.

This can generate an image obtained by performing analog binning on three pixels in the column direction. Consequently, the reading period ends. After the radiation detection panel 111 ends the reading period, the control circuit 112 controls the radiation detection panel 111 again, and the radiation detection panel 111 enters an accumulation period again and accumulates charges in the conversion elements C of the pixels 201. Then, the radiation detection panel 111 enters a reading period and performs the above series of reading processes. It is possible to achieve the provision of a moving image by repeating this processing. Such row analog binning is performed, whereby, when an n-th row and an (n+1)-th row as adjacent rows to be subjected to analog binning are read, the high levels are not simultaneously given to driving lines Vg(n) and Vg(n+1). Thus, it is possible to reduce the deterioration of line noise due to analog binning.

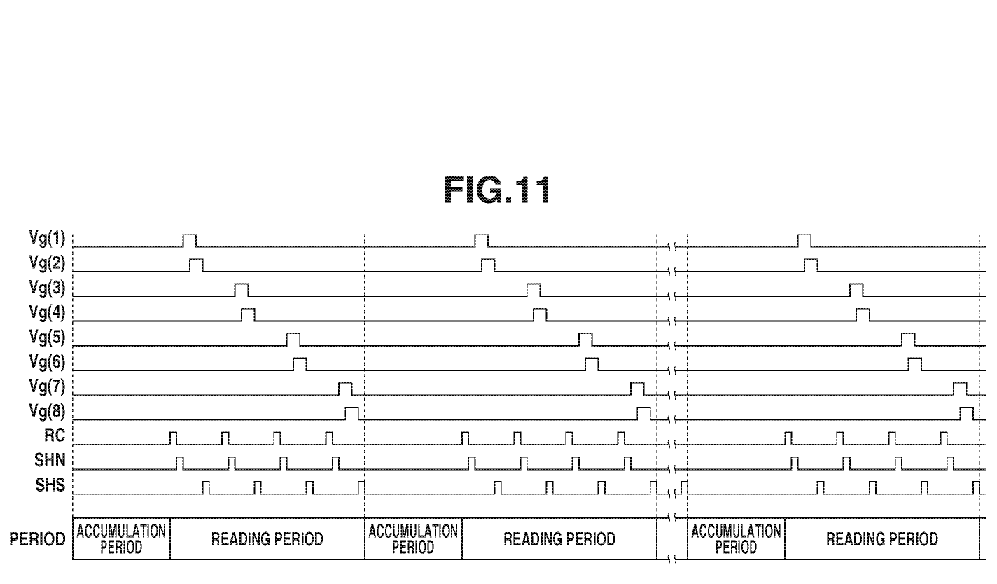

Also in the present embodiment, in the driving lines Vg(0) to Vg(2) as among adjacent rows to be subjected to analog binning, at the timing when the driving lines Vg(0) and Vg(2) are controlled to change from the high levels to the low levels, the driving lines Vg(1) and Vg(3) are simultaneously controlled to change from the low levels to the high levels. This can prevent an increase in the reading time. However, even if the reading time increases, but if the reading catches up with the achieved frame rate, the driving lines Vg(0) and Vg(2) may be controlled to change from the high levels to the low levels, and after a predetermined period elapses, the driving lines Vg(1) and Vg(3) may be controlled to change from the low levels to the high levels. Alternatively, as illustrated in FIG. 11, for example, before the driving lines Vg(0) and Vg(2) are controlled to change from the high levels to the low levels, the driving lines Vg(1) and Vg(3) may be controlled to change from the low levels to the high levels, thereby overlapping parts of the high level periods of driving lines Vg in adjacent rows. The overlap of the high level periods of the driving lines Vg has the advantage that it is possible to ensure a long time for the transfer time of charge signals from the output switch elements S. Although in the above description, a form has been employed in which conversion elements are not connected to the dummy driving line Vg(0), the present disclosure is not limited to this. A form may be employed in which dummy conversion elements are connected to the dummy driving line Vg(0).

For example, the dummy conversion elements may each be achieved by covering an upper portion of a conversion element with a light-blocking member and preventing the generation of a charge by light generated by the scintillator 316.

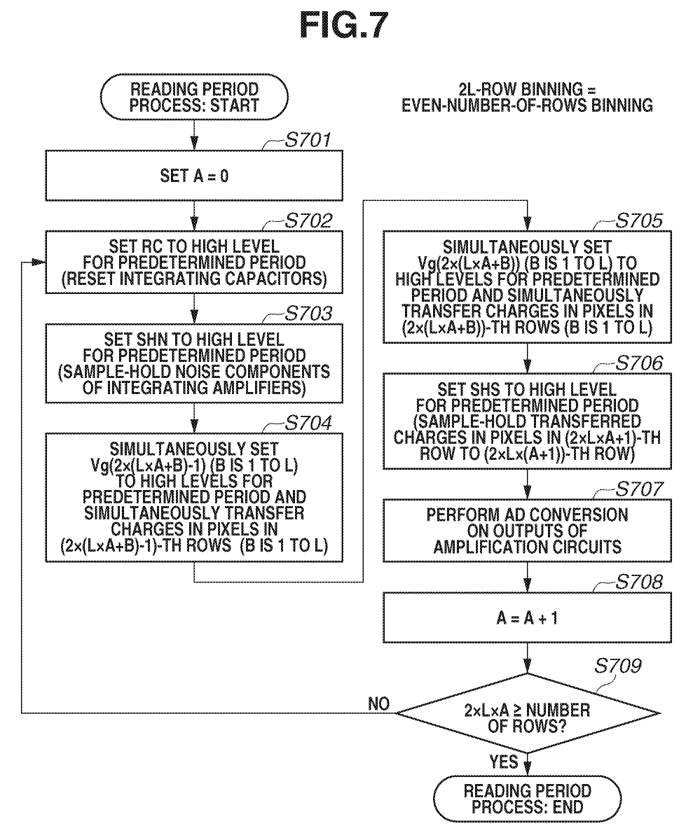

In the first and second embodiments, methods for two-row analog binning and four-row analog binning, respectively, have been described. However, processing during a reading period when not only these methods but also even-number-of-rows (2 × L) analog binning is performed can be generalized according to a flowchart in FIG. 7, and therefore is described below.

Although an example is illustrated where the pixels 201 are scanned from the row having the smallest row number to the row having the largest row number, the present disclosure is not limited to this. The pixels 201 may be scanned from the row having the largest row number to the row having the smallest row number.

If the radiation imaging apparatus 110 enters a reading period and starts a reading process, first, in step S701, the radiation imaging apparatus 110 resets the value of a counter A indicating the number of executions of the signal sample hold operation to 0. Then, in step S702, first, the control circuit 112 sets the control signal RC to the high level for a predetermined period. This corresponds to the reset operation on the integrating capacitors in the amplification circuits 221 connected to the signal lines Sig1 to Sig8 that is performed in the above embodiments. Next, in step S703, the control circuit 112 controls the control signal SHN to be at the high level for a predetermined period, thereby performing the noise sample hold operation in the integrating amplifiers 222 connected to the signal lines Sig1 to Sig8. Then, in step S704, the control circuit 112 sets driving lines Vg(2×(L×A+B)-1) to the high levels for a predetermined period. In this case, B is a number from 1 to L, and the control circuit 112 simultaneously transfers the charges accumulated in the conversion elements C of the pixels 201 connected to a total of L rows that are obtained by skipping every other row and are not adjacent to each other to the signal lines Sig1 to Sig8. For example, in the case of four-row binning (L = 2), A is 0, and B is 1 and 2. Thus, the control circuit 112 simultaneously controls the driving lines Vg(1) and Vg(3) to transfer the charges accumulated in the conversion elements C of the pixels 201 in the first and third rows of the pixel array 200. Next, in step S705, the control circuit 112 sets driving lines Vg(2×(L×A+B)) to the high levels for a predetermined period. Also in this case, B is a number from 1 to L, and the control circuit 112 simultaneously transfers the charges accumulated in the conversion elements C of the pixels 201 connected to a total of L rows adjacent to the rows in which the charges are transferred in step S704 to the signal lines Sig1 to Sig8. For example, in the case of four-row binning (L = 2), A is 0, and B is 1 and 2. Thus, the control circuit 112 simultaneously controls the driving lines Vg(2) and Vg(4) to transfer the charges accumulated in the conversion elements C of the pixels 201 in the second and fourth rows of the pixel array 200. Then, in step S706, the control circuit 112 controls the control signal SHS to be at the high level for a predetermined period, thereby performing the signal sample hold operation on the transferred charges in the pixels 201 connected to a (2×L×A+1)-th row to a (2×L×(A+1))-th row of the pixel array 200. For example, in the case of four-row binning (L = 2), the control circuit 112 performs the signal sample hold operation on the charges in the pixels 201 connected to the first to fourth rows. Then, in step S707, the control circuit 112 controls the multiplexer 227 and the reading circuit 220. Consequently, the difference between the output of the signal sample hold circuit and the output of the noise sample hold circuit of each of the amplification circuits 221 connected to the signal lines Sig1 to Sig8 is subjected to AD conversion in order. Consequently, for example, in the case of four-row binning (L = 2), image signals after the analog binning is performed on the pixels 201 connected to the first to fourth rows of the pixel array 200 are sequentially generated. Then, in step S708, the control circuit 112 increases the value of the counter A indicating the number of executions of the signal sample hold operation by 1, and the processing proceeds to a determination in step S709. In step S709, the control circuit 112 determines whether 2 × L × A is greater than the number of rows included in the pixel array 200. That is, the control circuit 112 determines whether the reading process by the analog binning in all the rows is completed. If the reading process by the analog binning in all the rows is not completed (No in step S709), the processing returns to step S702. Then, the reading by the analog binning is performed for the second time. In this case, in step S704, for example, in the case of four-row binning (L = 2), A is 1, and B is 1 and 2. Thus, the control circuit 112 controls the driving lines Vg(5) and Vg(7). In step S705, the control circuit 112 controls the driving lines Vg(6) and Vg(8). Then, in step S706, in the case of four-row binning (L = 2), the control circuit 112 performs the signal sample hold operation on the charges in the pixels 201 connected to the fifth to eighth rows of the pixel array 200. Then, in step S707, the resulting outputs are subjected to AD conversion, and image signals after the analog binning is performed are sequentially generated. Then, in step S708, the control circuit 112 increases the value of the counter A indicating the number of executions of the signal sample hold operation by 1. In step S709, the control circuit 112 determines whether 2 × L × A (A is 2 in this case) is greater than the number of rows included in the pixel array 200. If the number of rows included in the pixel array 200 is eight rows, the reading process by the analog binning in all the rows is completed, and the reading process in the reading period ends.

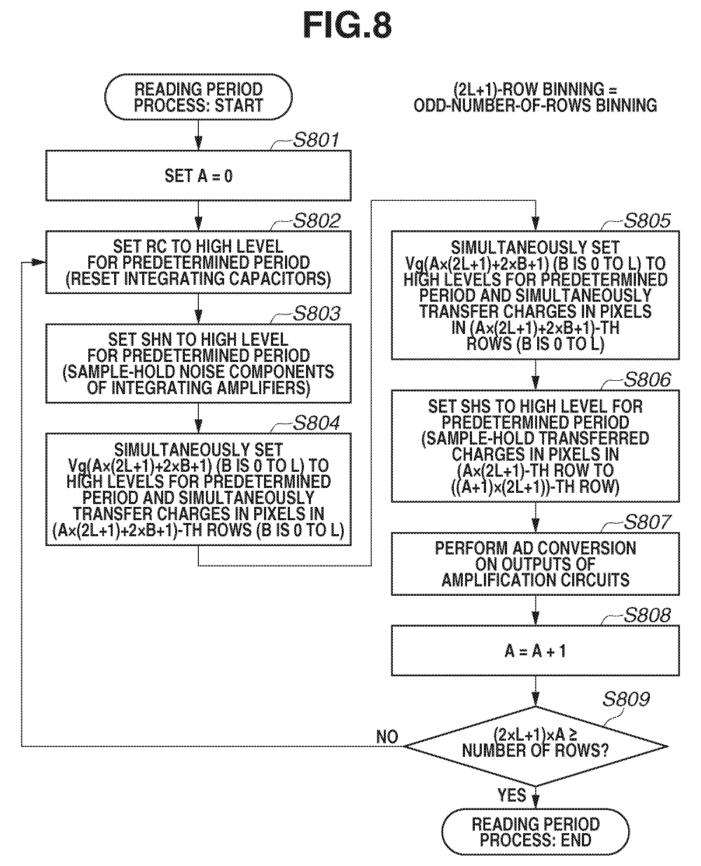

In the third embodiment, a method for three-row analog binning has been described. The present disclosure, however, is not limited to this. However, processing during a reading period when not only this method but also odd-number-of-rows (2 × L + 1) analog binning is performed can be generalized according to a flowchart in FIG. 8, and therefore is described below. Although an example is illustrated where the pixels 201 are scanned from the row having the smallest row number to the row having the largest row number, the present disclosure is not limited to this. The pixels 201 may be scanned from the row having the largest row number to the row having the smallest row number.

If the radiation imaging apparatus 110 enters a reading period and starts a reading process, first, in step S801, the radiation imaging apparatus 110 resets the value of the counter A indicating the number of executions of the signal sample hold operation to 0. Then, in step S802, first, the control circuit 112 sets the control signal RC to the high level for a predetermined period. This corresponds to the reset process on the integrating capacitors in the amplification circuits 221 connected to the signal lines Sig1 to Sig8 that is performed in the above embodiments. Next, in step S803, the control circuit 112 controls the control signal SHN to be at the high levels for a predetermined period, thereby performing the noise sample hold operation in the integrating amplifiers 222 connected to the signal lines Sig1 to Sig8. Then, in step S804, the control circuit 112 sets driving lines Vg(A×(2×L+1)+2×B) to the high level for a predetermined period. In this case, B is a number from 0 to L, and the control circuit 112 simultaneously transfers the charges accumulated in the conversion elements C of the pixels 201 connected to a total of L+1 rows that are obtained by skipping every other row and are not adjacent to each other to the signal lines Sig1 to Sig8. For example, in the case of three-row binning (L = 1), A is 0, and B is 0 and 1. Thus, the control circuit 112 transfers the charges accumulated in the conversion elements C of the pixels 201 in the zeroth and second rows of the pixel array 200. As illustrated in the third embodiment, the driving line Vg(0) in the zeroth row is a dummy driving line that is not used for a radiation image at the beginning of the driving circuit 210. Next, in step S805, the control circuit 112 sets driving lines Vg(A×(2×L+1)+2×B+1) to the high levels for a predetermined period. Also in this case, B is a number from 0 to L, and the control circuit 112 simultaneously transfers the charges accumulated in the conversion elements C of the pixels 201 connected to a total of L+1 rows adjacent to the rows in which the charges are transferred in step S804 to the signal lines Sig1 to Sig8. For example, in the case of three-row binning (L = 1), A is 0, and B is 0 and 1. Thus, the control circuit 112 controls the driving lines Vg(1) and Vg(3) to transfer the charges accumulated in the conversion elements C of the pixels 201 in the first and third rows of the pixel array 200. Then, in step S806, the control circuit 112 controls the control signal SHS to be at the high level for a predetermined period, thereby performing the signal sample hold operation on the transferred charges in the pixels 201 connected to an (A×(2×L+1))-th row to an ((A+1)×(2×L+1))-th row. For example, in the case of three-row binning (L = 1), the control circuit 112 performs the signal sample hold operation on the charges in the pixels 201 connected to the zeroth to third rows. As described above, since the zeroth row of the pixel array 200 is a dummy row that is not used for a radiation image, actually, the control circuit 112 performs the signal sample hold operation on the charges in the pixels 201 connected to the first to third rows. Then, in step S807, the control circuit 112 controls the multiplexer 227 and the reading circuit 220. Consequently, the difference between the output of the signal sample hold circuit and the output of the noise sample hold circuit of each of the amplification circuits 221 connected to the signal lines Sig1 to Sig8 is subjected to AD conversion in order. Consequently, for example, in the case of three-row binning (L = 1), image signals after the analog binning is performed on the pixels 201 connected to the first to third rows are sequentially generated. Then, in step S808, the control circuit 112 increases the value of the counter A indicating the number of executions of the signal sample hold operation by 1, and the processing proceeds to a determination in step S809. In step S809, the control circuit 112 determines whether (2 × L + 1) × A is greater than the number of rows included in the pixel array 200. That is, the control circuit 112 determines whether the reading process by the analog binning in all the rows is completed. If the reading process by the analog binning in all the rows is not completed (No in step S809), the processing returns to step S802. Then, the reading by the analog binning is performed for the second time. In this case, in step S804, for example, in the case of three-row binning (L = 1), A is 1, and B is 0 and 1. Thus, the control circuit 112 controls the driving lines Vg(3) and Vg(5) to transfer the charges in the pixels 201 connected to the third and fifth rows of the pixel array 200. In this case, since the charges are already transferred to the pixels 201 connected to the third row when the driving lines Vg(1) and Vg(3) are controlled, empty charges are transferred. This is equivalent to the transfer of only the charges in the pixels 201 connected to the fifth row. Then, in step S805, in the case of three-row binning (L = 1), A is 1 and B is 0 and 1. Thus, the control circuit 112 controls the driving lines Vg(4) and Vg(6). Then, in step S806, in the case of three-row binning (L = 1), the control circuit 112 performs the signal sample hold operation on the charges in the pixels 201 connected to the fourth to sixth rows. Consequently, in step S807, the resulting outputs are subjected to AD conversion, and image signals after the analog binning is performed are sequentially generated. Then, in step S808, the control circuit 112 increases the value of the counter A indicating the number of executions of the signal sample hold operation by 1. In step S809, the control circuit 112 determines whether (2 × L + 1) × A (A is 2 in this case) is greater than the number of rows included in the pixel array 200. If the number of rows included in the pixel array 200 is six rows, the reading process by the analog binning in all the rows is completed, and the reading process in the reading period ends. If the number of rows included in the pixel array 200 is nine rows (No in step S809), the processing returns to step S802. In steps S802 to S807, image signals equivalent to those after the analog binning is performed on the pixels 201 connected to the seventh to ninth rows of the pixel array 200 are sequentially generated. Then, in step S808, the control circuit 112 increases the value of the counter A indicating the number of executions of the signal sample hold operation by 1. Then, in step S809, (2 × L + 1) × A (A is 3 in this case) matches the number of rows included in the pixel array 200 (Yes in step S809), whereby the reading process by the analog binning in all the rows is completed, and the reading period process ends.

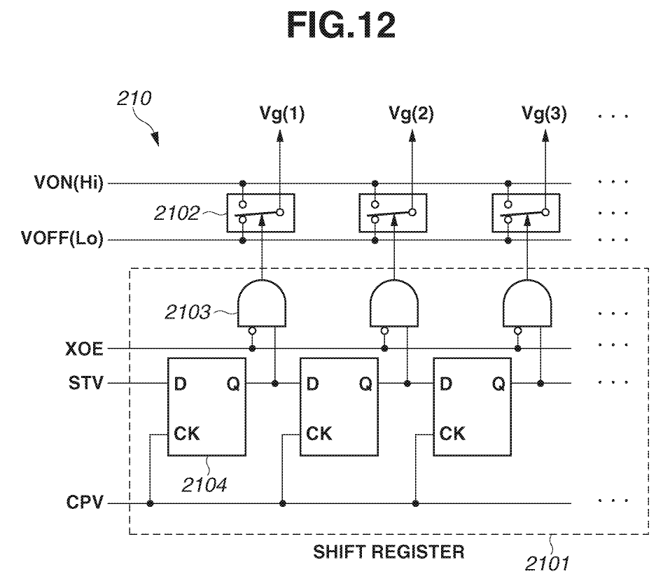

In all the above embodiments, as an example, as illustrated in FIG. 12, the driving circuit 210 that controls the driving lines Vg can have a circuit configuration including a shift register 2101 and a plurality of level shifters 2102. The shift register 2101 can be composed of a plurality of AND circuits 2103 and a plurality of D flip-flop circuits 2104. As the plurality of shift registers 2101, the plurality of AND circuits 2103, and the plurality of D flip-flop circuits 2104, as many shift registers 2101, AND circuits 2103, and D flip-flop circuits 2104 as the number of rows of the pixels 201 included in the pixel array 200 exist. Each level shifter 2102 sets the output to VON(Hi) when the output of the shift register 2101 input to the level shifter 2102 is at a high level. Each level shifter 2102 sets the output to VOFF(Lo) when the output of the shift register 2101 input to the level shifter 2102 is at a low level. Consequently, the driving line Vg connected to each level shifter 2102 is controlled to be at the high level or the low level.

The shift register 2101 operates according to signals XOE (output enable), STV (a start pulse), and CPV (a shift clock) supplied from the control circuit 112.

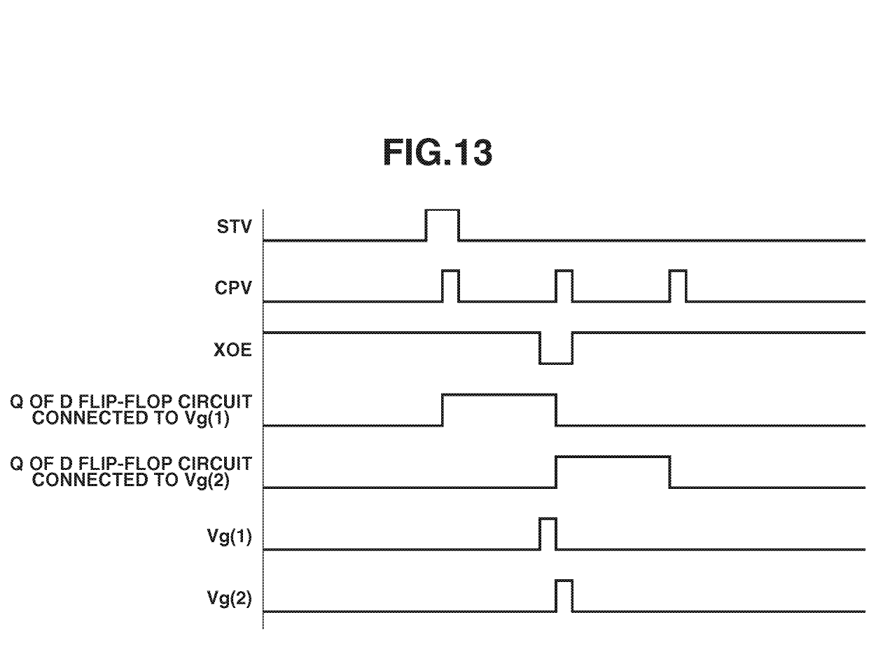

For example, in the case of the example of control of the analog binning operation in two adjacent rows illustrated in the first embodiment, the control circuit 112 can be achieved by supplying the signals XOE, STV, and CPV as in a timing chart illustrated in FIG. 13. The control circuit 112 sets the signal STV to a high level for a predetermined period and applies the pulsed signal CPV during the predetermined period, thereby setting an output Q of the D flip-flop circuit 2104 connected to the driving line Vg(1) to a high level. Then, the control circuit 112 sets the signal XOE to a low level, whereby the two inputs of the AND circuit 2103 connected to the driving line Vg(1) both change to high levels, and the output of the AND circuit 2103 shifts to a high level. This output is input to the level shifter 2102 connected to the driving line Vg(1), and the driving line Vg(1) changes to the high level. At this time, the control circuit 112 applies the pulsed signal CPV again while maintaining the signal XOE in the low level. Consequently, the output Q of the D flip-flop circuit 2104 connected to the driving line Vg(1) is shifted to an output Q of the D flip-flop circuit 2104 connected to the driving line Vg(2). Consequently, the output Q of the D flip-flop circuit 2104 connected to the driving line Vg(1) changes to a low level. Consequently, the output of the AND circuit 2103 connected to the driving line Vg(1) changes to a low level, and the output of the AND circuit 2103 connected to the driving line Vg(2) simultaneously changes to a high level. In this manner, it is possible to control the driving line Vg(1) to change from the high level to the low level and simultaneously control the driving line Vg(2) to change from a low level to the high level. Also after that, the signals CPV and XOE are appropriately applied, whereby it is possible to achieve the control of the driving lines Vg according to the first embodiment.

Also regarding the second and third embodiments, the manner of supplying the signals XOE, STV, and CPV is changed, whereby it is possible to shift the periods when the high levels are given to driving lines Vg in adjacent rows, while simultaneously giving the same level to a driving line Vg in a row that is not adjacent to the adjacent rows. Further, it is possible to control a driving line Vg in a certain row to change from the high level to the low level and simultaneously control a driving line Vg in a row adjacent to the certain row to change from the low level to the high level.

By the above method, it is possible to provide a radiation imaging apparatus capable of maintaining a high frame rate while reducing the visibility of line noise due to binning reading, and a radiation imaging system.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-200564, filed November 18, 2024, which is hereby incorporated by reference herein in its entirety.

What is claimed is:

1. A radiation imaging apparatus comprising:
a plurality of pixels, each including a conversion element configured to convert radiation or light into a charge and a switch element configured to control an output of the charge from the conversion element, is arranged in a matrix;
a driving unit configured to output driving signals that drive the switch elements;
a plurality of driving lines connecting the driving unit and the pixels with respect to each row and configured to supply driving signals output from the driving unit to the switch elements; and
a reading unit configured to read a charge from a pixel to which a driving signal is supplied, and generate an image data signal,
wherein after emission of radiation, the driving unit outputs a first driving signal to a first driving line among the plurality of driving lines and outputs a second driving signal to a second driving line adjacent to the first driving line by shifting timings to reduce line noise along the driving lines, and
wherein the reading unit generates an image data signal by totaling a first charge read from a pixel by the driving unit outputting the first driving signal to the first driving line and a second charge read from a pixel by outputting the second driving signal to the second driving line.

2. The radiation imaging apparatus according to claim 1, wherein the driving unit outputs the first and second driving signals to the first and second driving lines, respectively, so that a falling edge of the first driving signal and a rising edge of the second driving signal coincide with each other.

3. The radiation imaging apparatus according to claim 1, further comprising a processing unit configured to generate an image signal by processing the image data signal,
wherein the processing unit generates an image signal of a pixel connected to the first driving line and a pixel connected to the second driving line by processing the image data signal.

4. The radiation imaging apparatus according to claim 1,
wherein the driving unit outputs a third driving signal to a third driving line adjacent to the second driving line, outputs a fourth driving signal to a fourth driving line adjacent to the third driving line, outputs the first driving signal, and outputs the second driving signal by shifting timings to reduce line noise along the driving lines, and
wherein the reading unit generates an image data signal by totaling a third charge read from a pixel by the driving unit outputting the third driving signal to the third driving line, a fourth charge read from a pixel by outputting the fourth driving signal to the fourth driving line, the first charge, and the second charge.

5. The radiation imaging apparatus according to claim 4, wherein after outputting the first, second, third, and fourth driving signals, the driving unit outputs a fifth driving signal to a fifth driving line adjacent to either of the third and fourth driving lines, outputs a sixth driving signal to a sixth driving line adjacent to the fifth driving line, outputs a seventh driving signal to a seventh driving line adjacent to the sixth driving line, and outputs an eighth driving signal to one of the third and fourth driving lines by shifting timings to reduce line noise along the driving lines.

6. The radiation imaging apparatus according to claim 5, wherein the fifth driving line is adjacent to the fourth driving line, and the eighth driving signal is output to the fourth driving line.

7. The radiation imaging apparatus according to claim 4, wherein a conversion element connected to the first driving line is a dummy conversion element.

8. A radiation imaging apparatus comprising:
a plurality of pixels, each including a conversion element configured to convert radiation or light into a charge and a switch element configured to control an output of the charge from the conversion element, is arranged in a matrix;
a driving unit configured to output driving signals that drive the switch elements;
a plurality of driving lines connecting the driving unit and the pixels with respect to each row and configured to supply driving signals output from the driving unit to the switch elements; and
a reading unit configured to read a charge from a pixel to which a driving signal is supplied, and generate an image data signal,
wherein after emission of radiation, the driving unit outputs a first driving signal to a first driving line among the plurality of driving lines and outputs a second driving signal to a second driving line adjacent to the first driving line by shifting timings, and
wherein the reading unit generates an image data signal by totaling a first charge read from a pixel by the driving unit outputting the first driving signal to the first driving line and a second charge read from a pixel by outputting the second driving signal to the second driving line.

9. A radiation imaging system comprising:
the radiation imaging apparatus according to claim 1; and
a control apparatus configured to acquire an image signal from the radiation imaging apparatus and process the image signal.
